(19) United States
(12) Patent Application Publication
(10) Pub. No.: US 2006/0101346 A1
(43) Pub. Date: May 11, 2006

(54) Device and method for designing and planning an operating interface

(76) Inventor: Michael Denzlein, Zurich (CH)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/255,746

(22) Filed: Oct. 21, 2005

(30) Foreign Application Priority Data
Nov. 5, 2004 (EP) 04026386.5

(51) Int. Cl. G06F 3/00

(52) U.S. Cl. 715/762; 715/764

(57) ABSTRACT

The invention relates to a device and a method for designing and planning an operating surface, in particular a human-machine interface of an automation component. The design and planning of an operating surface is hereby simplified for the project planner by showing the connections of the components to be planned and designed.

### CROSS REFERENCE TO RELATED APPLICATIONS

This application claims priority to the European application No. 04026386.5, filed Nov. 5, 2004 which is incorporated by reference herein in its entirety.

### FIELD OF INVENTION

The invention relates to a device and a method for planning and designing an operating surface, in particular a human-machine interface of an automation component.

### BACKGROUND OF INVENTION

In the field of automation so-called operator panels are used to operate the automated unit or individual machines. The operator panels are standalone computer systems, linked via interfaces to control processor units (CPUs). So-called runtime software operates on the computer systems to implement the human-machine interface (HMI). The runtime software is hereby divided into a constant element, which is generally installed during production of the operator panel and a dynamic element, which is generated by so-called engineering systems. The dynamic element hereby includes the specific planning and design of the device or machine or the unit element for the respective production application.

### SUMMARY OF INVENTION

The data view for the engineering systems is screen-based, i.e., the primary unit used by a project planner to plan and design is a screen, on which individual elements are positioned, e.g. indicators for process values or navigation elements. These elements on the screen are in turn linked to process control units in the automation system, so that a temperature indicator on the screen for example is linked to a corresponding temperature sensor in a boiler. This link between the measured value indicator and the measured value detector is however not direct but is established via a chain of objects. For example the chain comprises the indicator element on the screen, a variable object and the control object on site.

During design and planning a project planner generally positions individual components on the screen of the operator panel to display and control the process data. The essential task of the project planner is then to establish connections between the components for display purposes and those for data storage and communication. This connection information is only accessible to the project planner in a highly distributed manner and in small units with the engineering systems currently in use.

A large number of manual steps at distributed points in the engineering system are required to obtain information for a chain from the actual control system to data storage to display, as in general engineering systems currently only provide a screen-based view. In order to establish the required connection between the components, the linked object generally has to be input in so-called property dialogs of the corresponding selected elements, e.g. the variable in the measured value indicator and the associated control system and storage address in the variable. It is relatively easy for errors to occur during these switching operations, with the project planer generally only being made aware of such errors during implementation of the design and planning.

However only syntactic errors, such as a missing connection, are generally discovered in this process. Semantic errors, e.g. a connection with an incorrect variable, are generally only discovered by the project planner when the operator panel in question is commissioned. With a semantic error it is also the case that it is complex for the project planner to search for errors. They have to check the connections for every possible element. Depending on the element, there may be up to a dozen option dialogs. For error analysis at present there is generally a so-called cross reference, i.e. the project planner is shown where a defined element is generally used. However a fast semantic check is very complex in this instance too.

The object of the present invention is to specify a device, which makes it easier for a project planner to design and plan an operating surface by displaying the links for the components to be designed and planned.

The object is achieved a device for designing and planning an operating surface, in particular a human machine interface of an automation component, with input means for positioning at least one display and/or input component on the operating surface to be designed and planned and indicator means for displaying data connections between the at least one display and/or input component and data providers and/or data takers of the display and/or input component of the operating surface to be designed and planned.

The invention is based on the knowledge that the data flow view provided in addition to the screen-based views available until now facilitates the work of the project planner significantly. The data flow view, which shows the data connections between the display or input component positioned on the screen surface by the project planner with their “communication partners”, i.e. the elements with which they exchange data, provides the project planner with a first overview of where the data and values are coming from and where they are going to or which interfaces generally have to be operated. The data flow view allows the project planner to see precisely which data connections exist between the component they are currently designing and all the other elements in the system. The project planer therefore has a simple overview of the data flows and does not have to call up the individual relevant elements associated with the component currently being designed to check the corresponding data connections there. For example all the data connections to the individual data inputs and outputs of one component can be displayed at the same time. It is no longer necessary as before to select the attributes individually from a navigation tree to check the data connections.

The data flow view that is also provided allows a project planner creating the runtime software at the same time to check whether all the data connections of relevance to the objector component to be displayed are also present. The project planner can also check whether the corresponding data connections indicate the correct target objects or whether they originate from the correct data sources. This facilitates the work of the project planner significantly, reducing both time and costs when using such an engineering system.

The result is a more natural view of what a project planner is working on. The operating device, for example the operator panel only shows the images but the difficult part of project planning is linking the information and actions to these images. The data flow view allows the project planner to create these links in a more specific fashion and to obtain an overview of them more easily. The project planner sees behind their images or the components represented by the images to the existing data flow modeling and can check this simply and quickly. Errors at link level can be found much more quickly, as information is available in an image, which would otherwise have had to be sought laboriously via different attributes of an object tree. With the data flow view it is possible to process or work on the links much more quickly, as the permitted links per element are very limited and the data flow editor can simply predefine the possible connections. Overall the device combines information that was previously distributed so that a clear overview can be obtained.

Further advantageous embodiments of the invention are specified in the subclaims. In particular a display and/or input component can be selected from a library using selection means. The indicator means, which show the data flow view of the designed and planned runtime software, can also be activated and deactivated. Individual data connections between the components and data providers and/or data takers shown by the indicator means can also be activated or deactivated. This allows the project planner to select a more or less complicated display of the respective connections. Similarly it is possible to increase or reduce the depth of analysis of the data flow view, i.e. different link stages or a different chain length can be selected for links between different elements. The data flow view can also be shown from any display or input components. The display and/or input component selected in each instance is then in the center of the display and all incoming or outgoing data connections are centralized on the selected component.

Individual display and/or input components can also be overlaid and hidden. This again allows the project planner to display the designed and planned operating surface with different levels of complexity.

### BRIEF DESCRIPTION OF THE DRAWINGS

The invention is described in more detail below with reference to the exemplary embodiment shown in the figures, in which:

FIG. 1 shows a standard engineering system showing a screen to be designed and planned,

FIG. 2 shows an engineering system with a data flow view,

FIG. 3 shows an engineering system with a data flow view over different stages,

FIG. 4 shows a data flow view focusing on different components,

FIG. 5 shows a data flow view with attribute display,

FIG. 6 shows an engineering system with a hitherto unlinked component,

FIG. 7 shows an engineering system with a hitherto unlinked component in the first work step,

FIG. 8 shows an engineering system with a hitherto unlinked component in the second work step,

FIG. 9 shows an engineering system with a linked component.

### DETAILED DESCRIPTION OF INVENTION

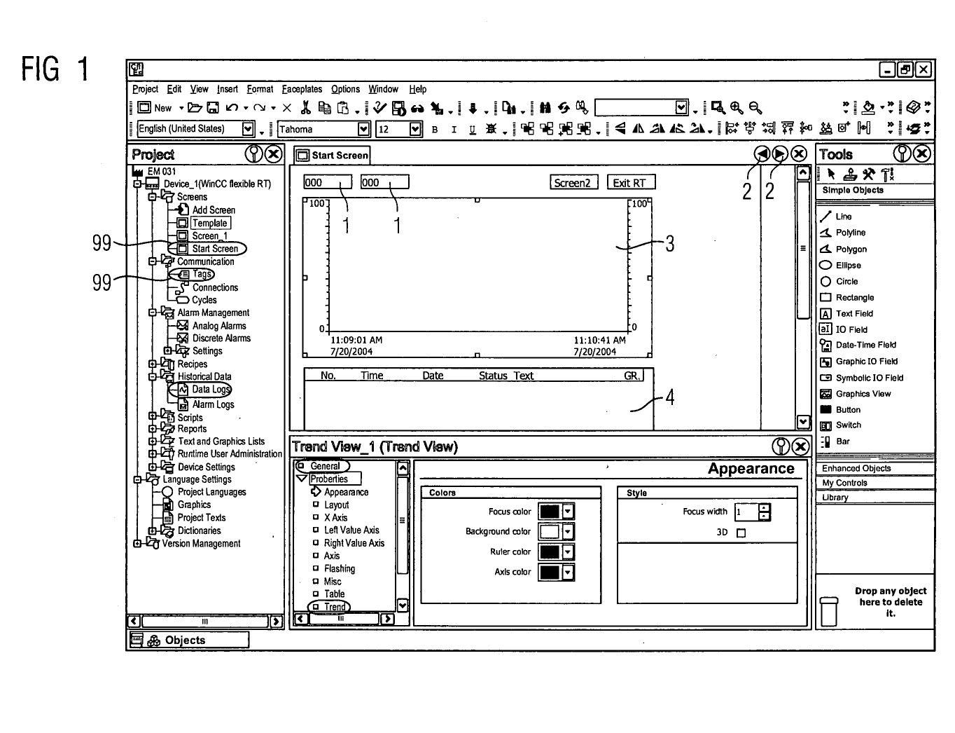

FIG. 1 shows a typical engineering system for automation systems as the prior art showing an exemplary screen. In this instance the screen contains two input/output fields to display and input data 1. The screen also contains two buttons for navigation 2 and a trend view 3 to indicate measured values graphically. The screen also contains a message view 4 to display messages from the system to the user. To check the links for these elements 1, 2, 3 and 4, the project planner would have to activate the elements 99 marked in FIG. 1 and also select further attributes for each element there, as marked for example for the trend view in its attribute panel 5. In the example shown the highlighting in the project tree is fairly limited due to the relatively simple example. In theory it could be necessary to activate all of the elements shown in the project tree and examine their content.

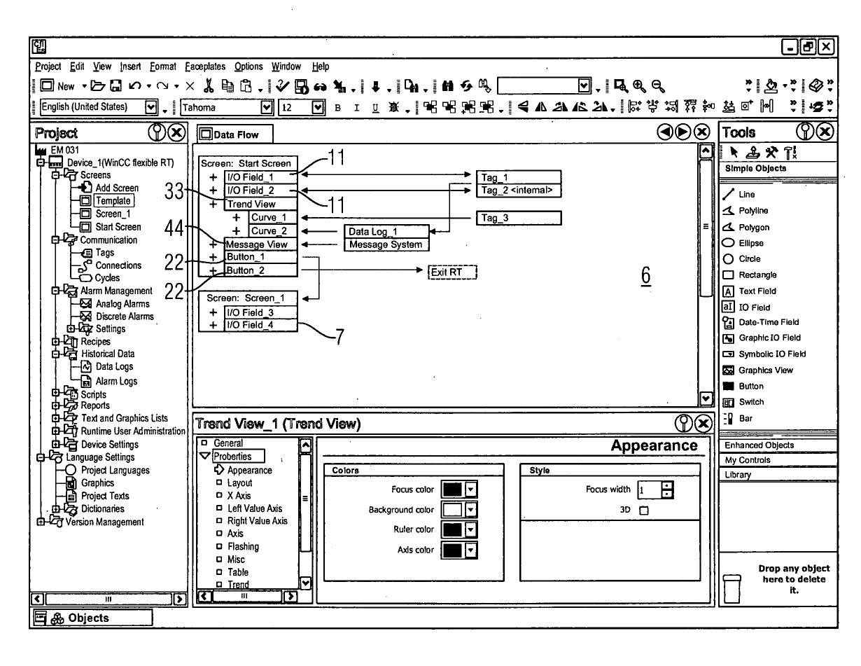

FIG. 2 shows the claimed device, in which a data flow view 6 is displayed in the context of the engineering system for the exemplary project planning, focusing on the screen. The start screen with the two input fields 11, the navigation buttons 22, the trend view 33 and the message view 44 is hereby shown as one component with different data inputs and outputs. In the first step only the direct connections to this start screen component are displayed. The starting point here is the “start screen” object. The data connections here are shown with solid lines. In addition to the data connections, navigation options are shown with a broken line, for example to a second screen screen_17.

The arrows show the data flow direction for the data connections—in other words whether it is a data taker or data provider or both. For example the input field 1 is connected to the Tag_1 and acquires its values from this. The same value is displayed at the some time in the trend view 33 by means of a curve. It is also easy to see in the data flow view that a further curve is displayed in the trend view 33, acquiring its value from the Tag_3. The two navigation buttons 22 are each connected by broken lines to their destination.

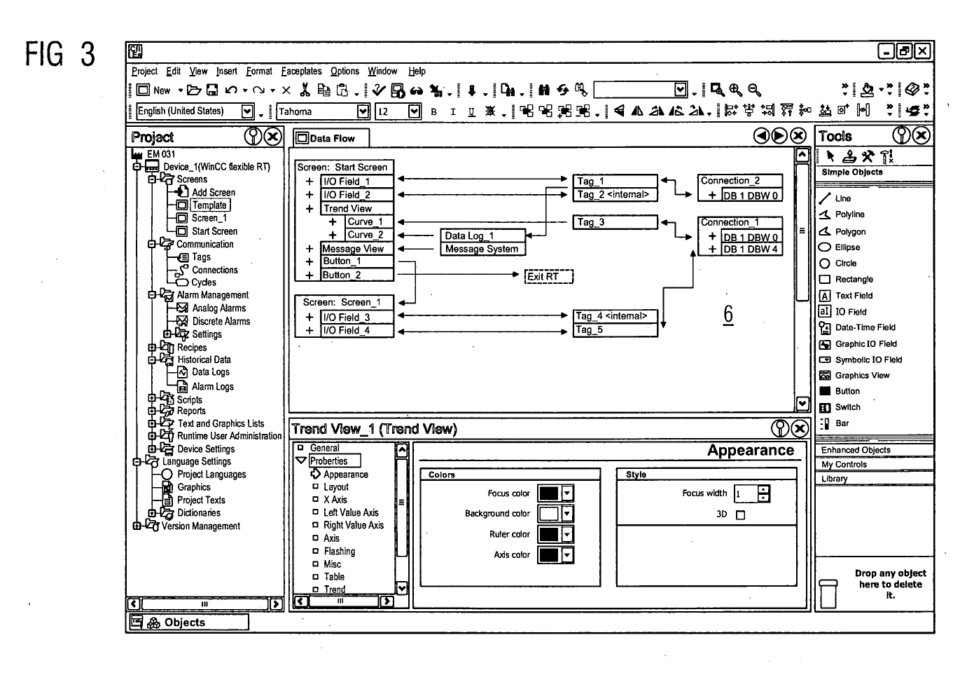

FIG. 3 also shows the data flow view 6 of the engineering system. However here the depth of analysis goes one stage further than FIG. 2. In other words all connections “two” removed from the “start screen” component are also displayed. These are connections that are connected not directly but via a further element to the start screen component. For example Tag_1 acquires its value via the connection Connection_2, which supplies a value for a field device.

For the purposes of simpler visualization, the display can also include a sub-network which represents a coherent path in a specific color. This can improve the clarity of unclear data flow views and make it easier for the user to follow the corresponding path in the diagram.

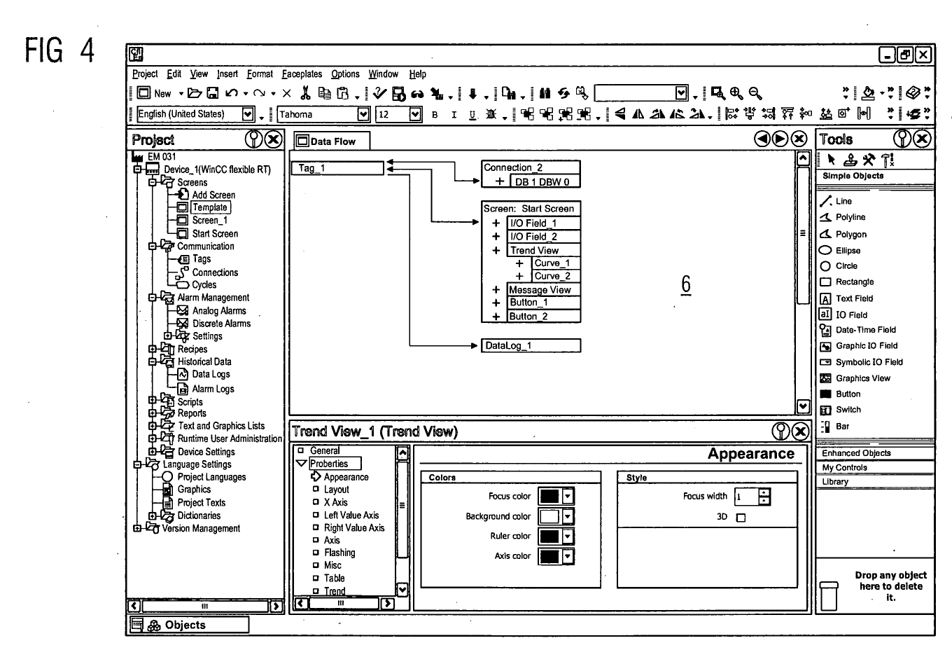

FIG. 4 shows the data flow view 6 of the engineering system. In contrast to FIGS. 2 and 3, in FIG. 4 the Tag_1 is the central element of the display. In this instance only the links from Tag_1 or to Tag_1 are shown starting from Tag_1. This shows that the Tag_1 has a connection to the Connection_2 and a connection to one of the input fields 1 of the “start screen”. It also shows that Tag_1 has a connection to Datalog_1. The change in view can for example be effected by double clicking on Tag_1. This changes the primary focus from the start screen component to the variable Tag_1. The connections to Tag_1 are now shown directly instead of the connections to start screen. It would also be possible to display an extension of the connection depth or the links, which go out via the direct connection to the respective component, in this view according to the data flow view 6 shown in FIG. 3.

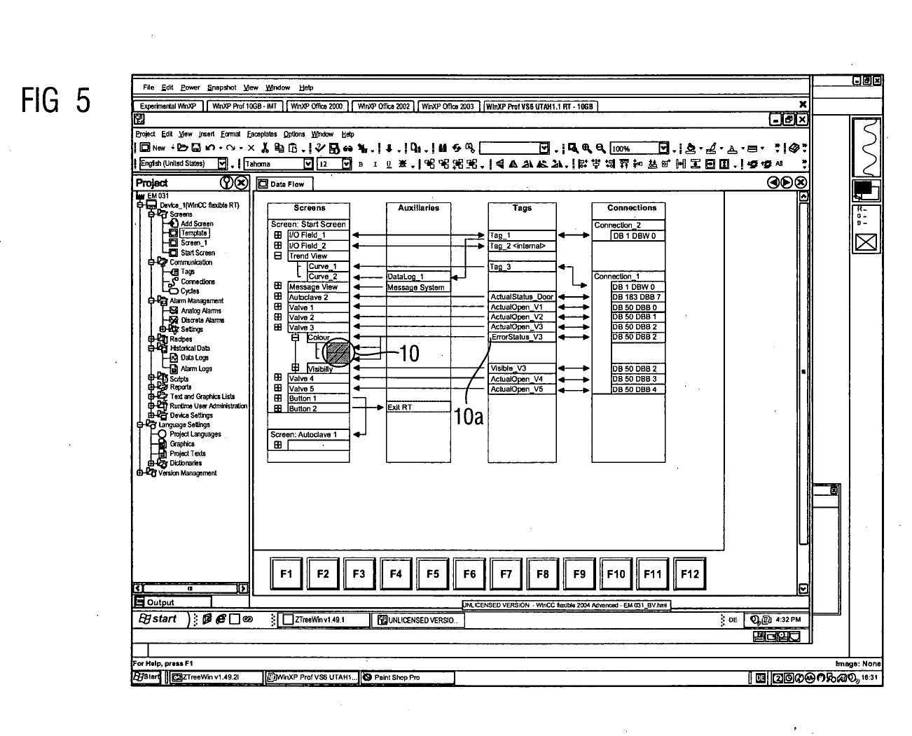

FIG. 5 shows the data flow view 6 of the engineering system with a further function. Here further attributes 10, in particular dynamic attributes, relating to a component to be displayed, for example Valve_3, are displayed as additional information. These attributes, for example visibility, color of display, flashes, position of element, can also be connected in the context of the claimed device to variables 10a, i.e. data providers and data takers. These connections are then also shown in the data flow view. For example the additional variable 10a can be used as a data provider in the event of an error and can color the component in this instance Valve_3, red if there is an error, otherwise green.

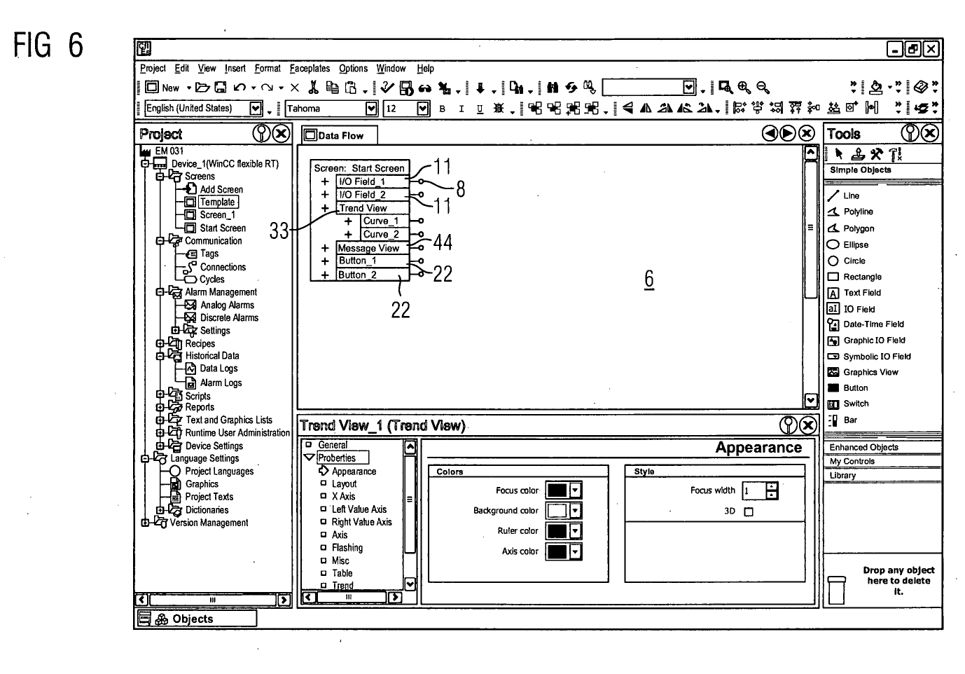

FIG. 6 shows by way of an example how a project planner can work with the device. Here a component, which is already positioned on the screen but not yet linked, is displayed in the data flow view 6. The component has its individual elements, for example input fields 11, navigation buttons 22, trend view 33 and message view 44. The links are however not yet created and the missing links are therefore represented by specific symbols, in this instance a hollow circle 8.

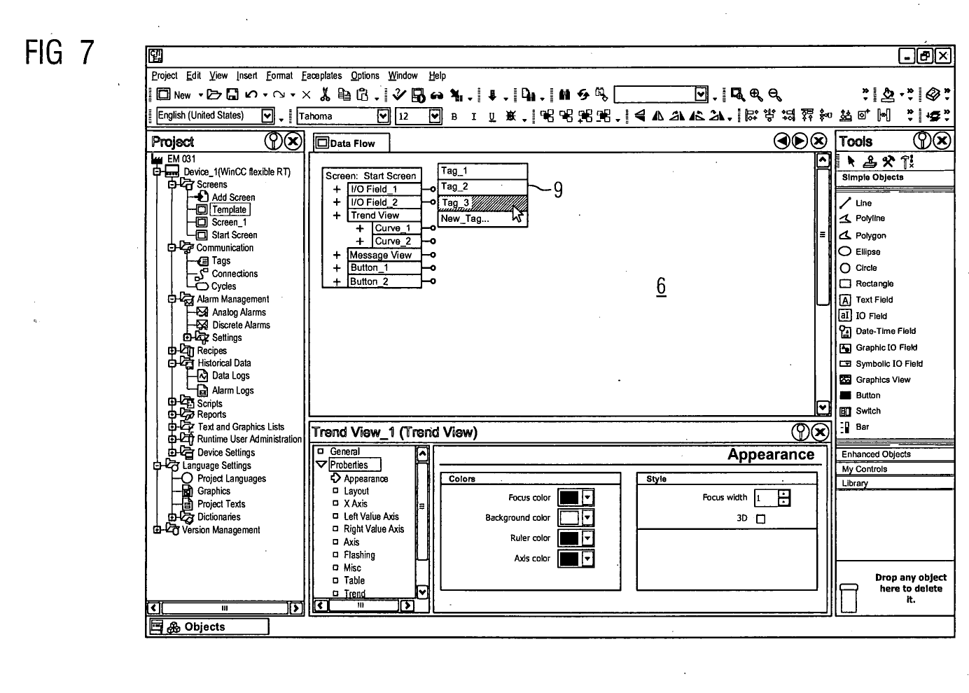

FIG. 7 shows the next step in the work with the claimed device. For example a connection to a tag is to be established in the window trend view 33 based on Curve_1. To this end the device or the engineering system lists the possible variables in the data flow view 6 of the type which would display an expedient link to this curve in the trend view 33. The variables are in the form of a list 9. The required element or variable, in this instance Tag_3 can be selected from this list 9.

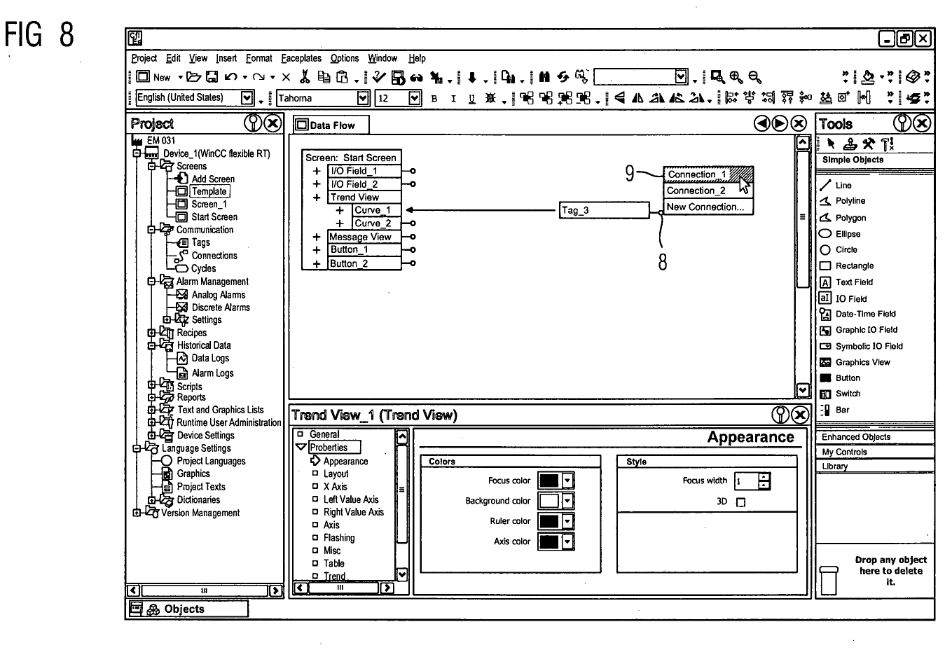

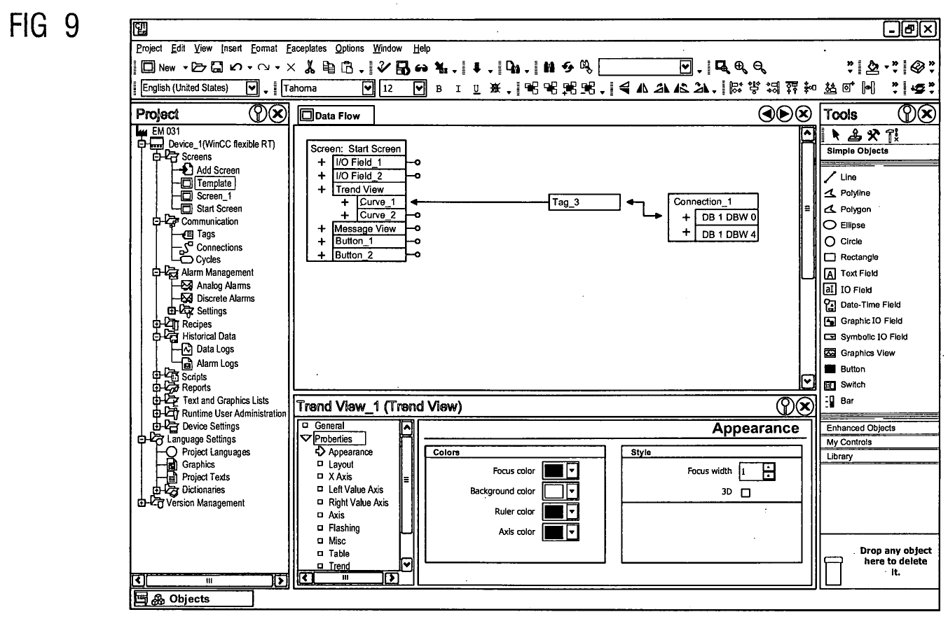

FIG. 8 shows the next step in project planning. The lied variable Tag_3 is not yet connected to a control system. Therefore the device also indicates at the input of Tag_3 that a connection is missing. This is done again by way of an example by means of a hollow circle 8. In the data flow view 6 a list of the possible data connections is given at the unlinked connections. The system thereby allows a selection to be made from two previously designed control systems or a corresponding connection to be newly set up. Widen a selection has been made from the possible options in the list 9, the connection is set up. The required chain between the curve to be displayed in the trend view and the necessary measured value or data is completed (FIG. 9).

1.-16. (canceled)

17. A device for designing and planning a visual operating surface, comprising:
an input unit for positioning at least one display element or input element on the operating surface; and
a display unit for visualizing data connections between the at least one display respectively input element and data providers or between the at least one display respectively input element and data users, the data providers respectively data users being local or remote users of the operating surface.

18. The device according to claim 17, wherein the operating interface is a human-machine interface of an automation device.

19. The device according to claim 17, further comprising a selection unit for selecting the at least one display element or input element.

20. The device according to claim 18, wherein the display unit is configured to be activated and deactivated upon request.

21. The device according to claim 17, wherein a plurality of display respectively input elements are positioned on the operating interface, and the display unit:
includes a number of views for visualizing the display or input elements, and
is configured to display any of the positioned display respectively input elements as a central element when visualizing the data connections.

22. The device according to claim 17, wherein a plurality of display respectively input elements are positioned on the operating interface, and the display unit is configured to put on focus or to hide each of the positioned display respectively input elements upon request.

23. The device according to claim 17, wherein the display unit is configured to visualize a plurality of levels regarding the data connections.

24. The device according to claim 17, wherein dynamic attributes are assigned to the display elements for providing detailed information on the display elements, the dynamic attributes configured to be linked to the data providers or data users.

25. A method of designing and planning a visual operating interface, comprising:
positioning at least one display element or input element on the operating interface; and
visualizing data connections between data providers or data users of the operating interface and the at least one display respectively input element.

26. The method according to claim 25, wherein the data providers respectively users are located remotely relative to the operating interface using a remote data connection.

27. The method according to claim 26, wherein the remote data connection is a data connection chosen from the group consisting of the internet, an intranet, a wireless connection, a satellite connection, a radio connection, a power line carrier connection and a hardwired connection.

28. The method according to claim 25, further comprising selecting at least one of the display or input component elements for displaying or manipulating the selected display respectively input element.

29. The method according to claim 25, wherein the visualization of the data connections is activated only upon request.

30. The method according to claim 25, wherein the visualization of the data connections is deactivated upon request.

31. The method according to claim 25, further comprising:
selecting at least one of the visualized data connections; and
deactivating the visualization of the at least one selected data connection such that the at least one selected data connection is not displayed.

32. The method according to claim 25, wherein
a plurality of views of the display respectively input elements are displayed, and
any of the positioned display respectively input elements are user-selectable as a central element when visualizing the data connections.

33. The method according to claim 25, wherein any positioned display respectively input element is user-selectable to be put on focus or be hidden upon request.

34. The method according to claim 25, wherein the visualization of the data connections includes visualizing a plurality of levels regarding the data connections.

35. The method according to claim 25, further comprising assigning dynamic attributes to the display elements and displaying the attributed for providing detailed information on the display elements, the dynamic attributes configured to be linked to the data providers or data users.
